(19) United States
(12) Patent Application Publication
(10) Pub. No.: US 2003/0127783 A1
(43) Pub. Date: Jul. 10, 2003

(54) Hydraulic damping bearing

(75) Inventors: Gerold Winkler, Birkenau (DE); Hanno Gaertner, Gorxheimertal (DE)

Correspondence Address: DAVIDSON, DAVIDSON & KAPPEL, LLC, 485 SEVENTH AVENUE, 14TH FLOOR, NEW YORK, NY, 10018, US

(73) Assignee: Carl Freudenberg KG, Weinheim (DE)

(21) Appl. No.: 10/339,100

(22) Filed: Jan. 9, 2003

(30) Foreign Application Priority Data
Jan. 10, 2002 (DE) DE 102 00 592.3

(51) Int. Cl. F16F 13/00; F16M 7/00

(52) U.S. Cl. 267/140.13

(57) ABSTRACT

A hydraulic damping bearing including a working chamber (1) and a compensating chamber (2) which are filled with damping fluid (3). A partition (4) is provided between the working chamber (1) and the compensating chamber (2), the partition having at least one damping conduit (5) which connects the working chamber (1) and the compensating chamber (2) in a fluid-conducting manner. The partition (4) is designed as a orifice cage and includes at least two orifice disks (6, 7) which are associated with each other in such a manner that they are axially adjacent in the direction (8) of the introduced vibrations. A diaphragm (9) that is capable of vibrating is axially arranged between the orifice disks (6, 7) to isolate higher-frequency vibrations, the partition additionally featuring an absorber channel to absorb idling vibrations. The absorber channel (10) is divided by the diaphragm (9) into two subchannels (11, 12) which are axially adjacent relative to each other and at least substantially liquid-tight with respect to each other. One subchannel opens out into the working chamber (1) and the other into the compensating chamber (2).

Priority to German Patent Application No. 102 00 592.3, filed Jan. 10, 2002 and hereby incorporated by reference herein, is claimed.

### BACKGROUND INFORMATION

The present invention relates to a hydraulic damping bearing including a working chamber and a compensating chamber which are filled with damping fluid, a partition being provided between the working chamber and the compensating chamber, the partition having at least one damping conduit which connects the working chamber and the compensating chamber in a fluid-conducting manner, the partition being designed as a orifice cage and including at least two orifice disks which are associated with each other in such a manner that they are axially adjacent in the direction of the introduced vibrations, and a diaphragm that is capable of vibrating being axially arranged between the orifice disks to isolate higher-frequency vibrations.

A bearing of this kind is known from German Patent No. 38 09 166 C2. The bearing is designed as a hydraulic damping dual-chamber engine mount, the partition being horizontally divided into two symmetrical halves. The damping conduit is arranged in the radially outer region of the partition. The partition has a central opening in which is clamped a rubber-elastic diaphragm which features a cylindrically thickened edge region and a continuously thickened central diaphragm portion that is connected to the edge region via a web having a small thickness. The absorption of idling vibrations through the previously known bearing is not very satisfactory.

### BRIEF SUMMARY OF THE INVENTION

An object of the present invention is to further develop a bearing of the type mentioned at the outset in such a manner that, in addition to isolating higher-frequency vibrations and damping lower-frequency vibrations in a speed range above the idling speed, respectively, it is made possible to absorb idling-related vibrations.

To achieve the objective, provision is made for a hydraulic damping bearing including a working chamber and a compensating chamber which are filled with damping fluid, a partition being provided between the working chamber and the compensating chamber, the partition having at least one damping conduit which connects the working chamber and the compensating chamber in a fluid-conducting manner. The partition is designed as a orifice cage and includes at least two orifice disks which are associated with each other in such a manner that they are axially adjacent in the direction of the introduced vibrations. A diaphragm capable of vibrating is axially arranged between the orifice disks to isolate higher-frequency vibrations. The partition additionally features an absorber channel to absorb idling vibrations, the absorber channel being divided by the diaphragm into two subchannels which are axially adjacent relative to each other and at least substantially liquid-tight with respect to each other. One of the two subchannels opens out into the working chamber and the other into the compensating chamber.

In this context, it is an advantage that the bearing according to the present invention, in addition to isolating higher-frequency vibrations and damping lower-frequency vibrations, makes it possible to absorb idling vibrations, with the diaphragm vibrating out of phase in the region of the absorber channel, preferably 180 degrees out of phase with the introduced idling vibrations. The out-of-phase vibration of the diaphragm in the region of the absorber channel occurs exclusively in the range of the idling speed but, however, not in a speed range above the idling speed. The working properties of the bearing according to the present invention are particularly advantageous if the diaphragm separates the subchannels from each other in completely liquid-tight manner.

While an internal combustion engine supported on the inventive bearing is operated above the idling speed, the bearing works as generally known, hydraulic damping bearings in which the diaphragm is able to move back and forth within the partition between the orifice disks to isolate higher-frequency, low-amplitude vibrations. In order to damp low-frequency, large-amplitude vibrations, which occur, for example, when driving over curb edges, the liquid column located inside the damping conduit vibrates back and forth in a phase-shifted manner/180 degrees out of phase, thus damping the low-frequency, large-amplitude vibrations.

In relation to its varied functions, the bearing according to the present invention has an exceptionally simple design requiring a small number of parts and therefore is inexpensive to manufacture.

According to an advantageous embodiment, provision can be made for the diaphragm to be formed in one piece. In particular, the assembly of the two orifice disks forming the partition with the diaphragm being placed in between is considerably simplified by such a design because the preassembled unit composed of the orifice disks and the mounted diaphragm is formed of only three component parts. Furthermore, in comparison with diaphragms having a multipart design, a diaphragm formed in one piece has the advantage that the components of the diaphragm do not need to be sealed separately.

The diaphragm is preferably composed of an elastomeric material for good absorption of idling vibrations and for isolating higher-frequency, low-amplitude vibrations, as occur, for example, above the idling speed.

In order to absorb the idling vibrations, the diaphragm can have a thickness of 0.5 to 2.0 mm in the central region. Diaphragms designed in this manner have good working properties for most application cases because, on one hand, they are sufficiently resistant to mechanical stress and, on the other hand, have good flexibility all the same.

Diaphragms having a thickness of less than 0.5 mm have an unsatisfactory service life for some application cases because, due to the comparatively small thickness, especially in the region of the largest bending loads, cracks can occur which adversely change the working properties because damping fluid passes from the working chamber into the compensating chamber and back again in an undefined manner. On the other hand, if the diaphragm thickness is greater than 2.0 mm, the diaphragm is not sufficiently flexible for most application cases so that idling vibrations are absorbed only insufficiently.

In the region of the outer peripheral edge of the absorber channel, the diaphragm can be associated with stops of the partition on both sides in an axial direction such that it is adjacent to the stops at an axial distance. In this connection, it is an advantage that the diaphragm has the highest possible flexibility within the absorber channel in an axial direction, that is, in the direction of the introduced vibrations and that the unwanted idling vibrations are thereby absorbed particularly efficiently.

A distance which of 0.2 to 2.5 mm from each of the axially neighboring adjacent stops in the axial direction on both sides of the diaphragm is particularly advantageous, the ratio of the thickness of the diaphragm to the respective distance preferably being 1. When dimensioning the distance from the stops in such a manner, it is an advantage that the diaphragm does not touch the stops while absorbing the idling vibrations in order to achieve as optimum an absorption of the idling vibrations as possible. Only when large-amplitude, low-frequency vibrations are introduced into the bearing, i.e., when damping fluid is displaced through the damping conduit from the working chamber to the compensating chamber and back again, does the diaphragm makes contact with the stops located in the chamber with the comparatively lower pressure. The stops protect the diaphragm from undesirably high mechanical stress and, as a result, from damage/destruction.

In order to change the characteristic curve of the dynamic spring rate over the frequency, it is possible to provide the diaphragm with modifications. In this context, the diaphragm can have a material accumulation which is designed as an additional absorber mass and located within the absorber channel, the whole diaphragm being formed of a uniform material. In this connection, it is an advantage that a diaphragm of that kind is easy and inexpensive to manufacture. Moreover, such a diaphragm can be recycled purely by type of material.

According to another embodiment, the diaphragm can have a separately produced, additional absorber mass within the absorber channel, the additional absorber mass being completely or at least partially enclosed by the material of the diaphragm. An additional absorber mass of that kind can be formed, for example, of a metal disk. A disk which is completely enclosed by the material of the diaphragm is well protected from external influences. Therefore, it is not necessary to carry out separate corrosion protection measures.

The absorber channel is preferably located centrally in the partition. The working properties of a bearing designed in such a manner and its ease of manufacture are advantageous.

Within the absorber channel, the diaphragm can have a central region which is connected to the annular edge region of the diaphragm by a substantially rolling-bellows shaped connection, the edge region being able to move axially back and forth between the orifice disks to isolate higher-frequency vibrations. The rolling-bellows shaped connection of the central region to the edge region ensures excellent flexibility and ability of the central region to move back and forth relative to the edge region, which is an advantage to be emphasized with regard to an efficient absorption of idling vibrations. Moreover, the rolling-bellows shaped connection prevents tensile and/or shear stresses in this region that would reduce the service life. Thus, the bearing possesses working properties of constant quality during a long service life.

Accordingly, the diaphragm formed in one piece has two functions. In order to absorb idling vibrations, the central region is able to move back and forth in an axial direction such that it is out of phase with the introduced idling vibrations. In contrast, the annular edge region is able to move back and forth between the orifice disks in an axial direction to isolate higher-frequency, low-amplitude vibrations occurring above the idling speed. Because both functions are combined in the diaphragm, the bearing is altogether easy and inexpensive to manufacture.

The edge region can feature a surface profile on at least one of its surfaces facing the orifice disks. This has the advantage that unwanted impact noises of the diaphragm on the orifice disks are prevented.

At least one of the orifice disks can be composed of a polymeric material and be able to be snap-secured to the respective other orifice disk with the diaphragm being placed in between. Preferably, both orifice disks can be composed of a polymeric material. Such orifice disks can be produced, for example, by injection molding. Using such a process, it is also possible to produce comparatively complicated shapes in a simple and cost-effective manner. Furthermore, the preassembled unit composed of the two orifice disks and the diaphragm has only a small mass, which is why the bearing is also suitable for light construction applications.

Due to its cost-effective manufacturability, the functionally versatile bearing can also be used, for example, in vehicles of the lower price ranges.

### BRIEF DESCRIPTION OF THE DRAWING

The bearing according to the present invention is explained in greater detail below with reference to the drawings, of which

FIG. 1 shows an exemplary embodiment of a partition of a bearing according to the present invention in a perspective and cross-sectional view;

FIG. 2 depicts a first exemplary embodiment of a diaphragm from FIG. 1;

FIG. 3 shows a second exemplary embodiment of a diaphragm from FIG. 1;

FIG. 4 shows a third exemplary embodiment of a diaphragm from FIG. 1; and

FIG. 5 is a perspective and cross-sectional view of a hydraulic bearing including the partition from FIG. 1.

### DETAILED DESCRIPTION

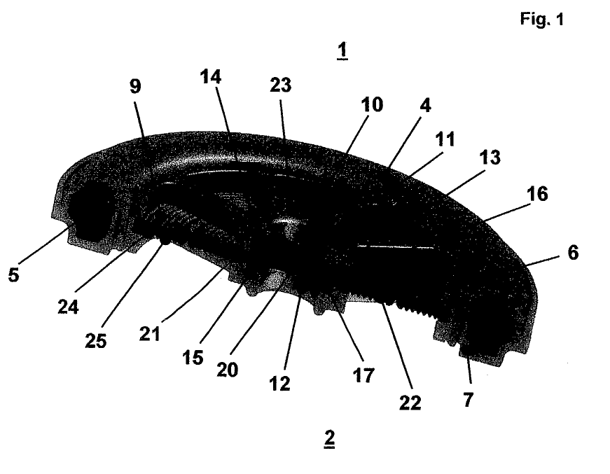

In FIG. 1, a partition 4 of a hydraulic bearing is shown in a perspective and cross-sectional view. Partition 4 includes an upper 6 and a lower orifice disk 7 which, in this exemplary embodiment, are each composed of polymeric material and able to be snap-secured to each other, i.e., forming a positive lock, with diaphragm 9 being placed in between.

In each of the exemplary embodiments, diaphragm 9 is formed in one piece, composed of an elastomeric material, and has a thickness of 1.3 mm in the central region. Partition 4 includes three functional regions, as viewed from radially outward to radially inward. Damping conduit 5, which connects working chamber 1 and compensating chamber 2 in a fluid-conducting manner, is arranged radially outward in partition 4. The radially outward arrangement of damping conduit 5 is useful to achieve as large a liquid column as possible with as large a mass as possible inside damping conduit 5 to be able to effectively dampen low-frequency, large-amplitude vibrations.

Located radially within damping conduit 5 is annular edge region 22 of diaphragm 9 which surrounds central region 20 of diaphragm 9 on the outer peripheral side, the annular edge region and the central region being formed of uniform material in such a manner that they integrally merge into one another. In the exemplary embodiments shown here, central region 20 and edge region 22 are interconnected by a substantially rolling-bellows shaped connection 21, edge region 22 featuring a surface profile 25 in the form of concentric ribs on each of its surfaces 23, 24 facing orifice disks 6, 7.

In the region of outer peripheral edge 13 of absorber channel 10, diaphragm 9 is associated with stops 14, 15 of partition 4 on both sides in an axial direction such that it is adjacent to the stops at an axial distance 16, 17, the ratio of the thickness of diaphragm 9 to axial distance 16, 17 being approximately 1.

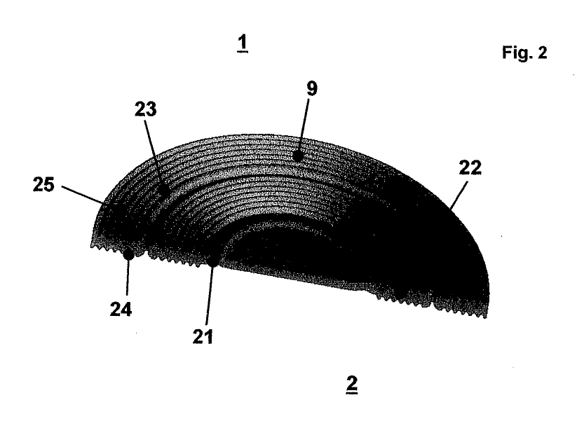

FIG. 2 is a perspective and cross-sectional view of diaphragm 9 from FIG. 1.

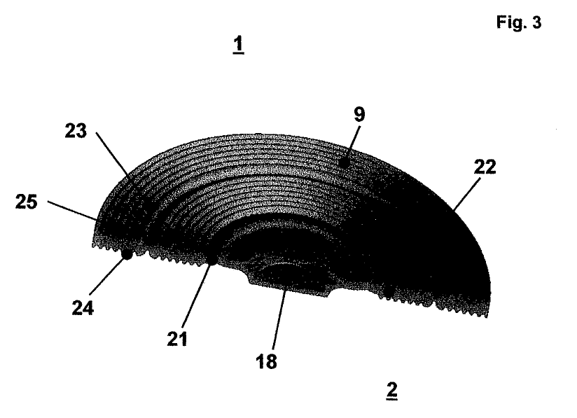

FIG. 3 depicts an alternative embodiment of diaphragm 9 which differs from the diaphragm from FIG. 2 in that diaphragm 9 has a material accumulation which is located in its central region 20 within absorber channel 10 and designed as an additional absorber mass 18, making it possible to adapt the characteristic curve of the dynamic spring rate over the frequency.

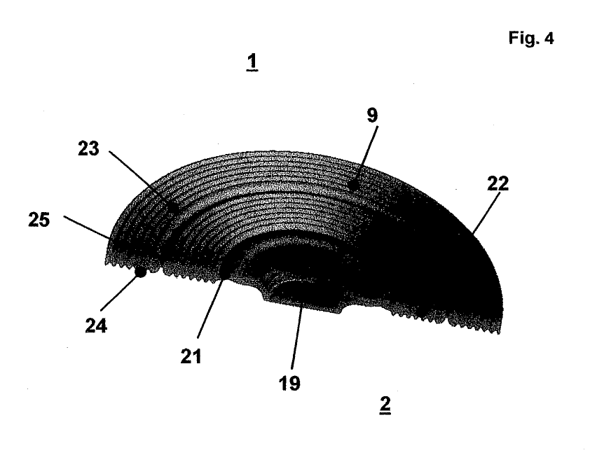

FIG. 4 shows a further exemplary embodiment of a diaphragm 9 which has a similar designed as diaphragm 9 from FIG. 3. Diaphragm 9 from FIG. 4 differs therefrom in that it has a separately produced, additional absorber mass 19 in central region 20 within absorber channel 10, the additional absorber mass being composed of a metallic material and having a disk-shaped design. Additional absorber mass 19 is completely enclosed by the elastomeric material of diaphragm 9.

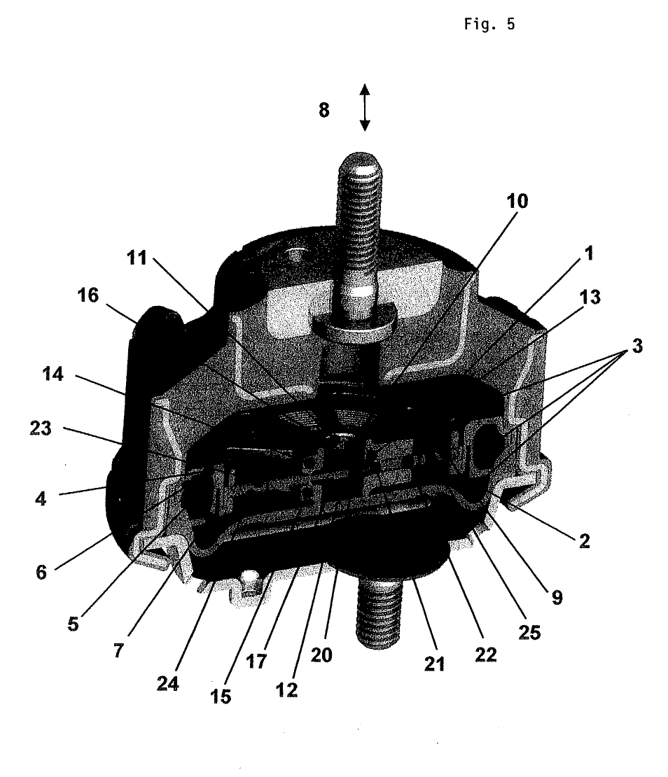

FIG. 5 depicts a hydraulic damping bearing in which a partition 4 according to FIG. 1 is used. The bearing includes a working chamber 1 and a compensating chamber 2 which are each filled with damping fluid 3. Partition 4 is arranged between working chamber 1 and compensating chamber 2, working chamber 1 and compensating chamber 2 being connected by damping conduit 5 in a fluid-conducting manner. Diaphragm 9, which is capable of vibrating in the direction of the introduced vibrations, is axially arranged between orifice disks 6, 7, partition 4 additionally featuring an absorber channel 10 to absorb idling vibrations. Absorber channel 10 is divided by diaphragm 9 into two subchannels which are axially adjacent relative to each other and liquid-tight with respect to each other and of which one 11 opens out into working chamber 1 and the other 12 into compensating chamber 2. By suitably dimensioning absorber channel 10, a natural vibration of the fluid with diaphragm 9 in central region 20 or of absorber mass 19 is adjusted, resulting in an absorber effect. This absorber precedes the forced movements of the bearing, thus reducing the dynamic stiffness of the bearing. For smaller excitation amplitudes, this dynamic stiffness is far below the basic static stiffness of the bearing. The absorber effect can be adjusted in a frequency range from 10 to 90 Hertz. In the case of excitation frequencies which are above the adjusted natural frequency, the fluid column begins to vibrate 180 degrees out of phase in the absorber channel; the dynamic spring rate increases.

What is claimed is:

1. A hydraulic damping bearing comprising:
a working chamber and a compensating chamber filled with damping fluid,
a partition between the working chamber and the compensating chamber, the partition having at least one damping conduit connecting the working chamber and the compensating chamber in a fluid-conducting manner, the partition being designed as a orifice cage and including at least two orifice disks axially adjacent in a direction of introduced vibrations, and
a diaphragm being axially arranged between the orifice disks a capable of isolating higher-frequency vibrations, the partition having an absorber channel to absorb idling vibrations, the absorber channel being divided by the diaphragm into two subchannels axially adjacent relative to each other and at least substantially liquid-tight with respect to each other, a first of the two subchannels opening out into the working chamber and a second of the two subchannels into the compensating chamber.

2. The bearing as recited in claim 1 wherein the diaphragm is formed in one piece.

3. The bearing as recited in claim 1 wherein the diaphragm is composed of an elastomeric material.

4. The bearing as recited in claim 1 wherein the diaphragm has a central region with a thickness of 0.5 to 2.0 mm.

5. The bearing as recited in claim 1 the diaphragm in a region of an outer peripheral edge of the absorber channel is associated with stops of the partition on both sides in an axial direction such that the diaphragm is adjacent to the stops at an axial distance.

6. The bearing as recited in claim 5 wherein a distance from each of the axially neighboring adjacent stops in the axial direction on both sides of the diaphragm is 0.2 to 2.5 mm.

7. The bearing as recited in claim 1 wherein the diaphragm has a material accumulation designed as an additional absorber mass and located within the absorber channel.

8. The bearing as recited in claim 1 wherein the diaphragm has a separately produced, additional absorber mass within the absorber channel, the additional absorber mass being completely or at least partially enclosed by the material of the diaphragm.

9. The bearing as recited in claim 1 wherein the absorber channel is located centrally in the partition.

10. The bearing as recited in claim 1 wherein within the absorber channel, the diaphragm has a central region connected to an annular edge region of the diaphragm by a substantially rolling-bellows shaped connection, the edge region being able to move axially back and forth between the orifice disks to isolate higher-frequency vibrations.

11. The bearing as recited in claim 10 wherein the edge region features a surface profile on at least one of its surfaces facing the orifice disks.

12. The bearing as recited in claim 1 wherein at least one of the orifice disks is composed of polymeric material and is able to be snap-secured to the respective other orifice disk with the diaphragm being placed in between.
